(19) United States
(12) Patent Application Publication
(10) Pub. No.: US 2026/0003870 A1
(43) Pub. Date: Jan. 1, 2026

(54) SYSTEMS AND METHODS FOR MULTISTAGE INFORMATION RETRIEVAL AND SYNTHESIS

(71) Applicant: DEEP RESEARCH LLC, San Francisco, CA (US)

(72) Inventor: David L. SIFRY, San Francisco, CA (US)

(21) Appl. No.: 19/257,307

(22) Filed: Jul. 1, 2025

Related U.S. Application Data
(60) Provisional application No. 63/666,570, filed on Jul. 1, 2024.

(51) Int. Cl. G06F 16/2455; G06F 16/2457

(52) U.S. Cl. CPC G06F 16/2455; G06F 16/24578

(57) ABSTRACT

A method for multistage information processing includes receiving a user query from a user device; transforming the user query into semantic vectors in a high-dimensional space using a machine learning algorithm; comparing the semantic vectors to a database of pre-vectorized documents; ranking documents by closeness to the vectors to select a subset; generating metadata from the selected documents via a large language model; synthesizing the metadata into a comprehensive summary; and transmitting the summary to the user device in response to the user query.

### CROSS-REFERENCE TO RELATED APPLICATION(S)

The present application claims priority to U.S. Provisional Patent Application No. 63/666,570, Titled “SYSTEMS AND METHODS FOR MULTISTAGE INFORMATION RETRIEVAL AND SYNTHESIS” and filed Jul. 1, 2024, the entirety of which is incorporated by reference herein.

### TECHNICAL FIELD

The present disclosure relates generally to systems and methods for multistage information retrieval and synthesis.

### BACKGROUND

In the realm of information retrieval and processing, the ability to accurately and efficiently extract relevant information from a large corpus of documents is a challenge of paramount concern. Traditional search engines often rely on keyword-based searches to retrieve relevant documents. However, this method has limitations in understanding the conceptual relevance of documents to a given query. The keyword-based approach often fails to capture the semantic nuances and context of the query, leading to less accurate and relevant results.

Moreover, advanced techniques such as large language models (LLMs) and retrieval augmented generation (RAG) have been employed to improve the quality of information retrieval. These techniques leverage machine learning algorithms to understand the context and semantics of the query, thereby improving the relevance of the retrieved documents. However, these methods also suffer from their own set of limitations. One such issue is the phenomenon of “hallucination”, where LLMs generate information that sounds reasonable but isn't substantiated by the source documents. This can lead to the retrieval of inaccurate or misleading information, which is a major concern in fields where the accuracy of information is of utmost priority.

Furthermore, the process of synthesizing the retrieved information into a coherent and comprehensive summary is another challenge. Traditional methods often fail to effectively combine the information from multiple documents, leading to fragmented and disjointed summaries. This makes it difficult for the user to understand the synthesized information and can lead to misinterpretation of the information.

Therefore, there is a clear and pressing demand for improved methods and systems for information retrieval and synthesis. Such methods and systems would ideally address the limitations of both keyword-based searches and advanced techniques like LLMs and RAG, while also providing an effective way to synthesize the retrieved information into a comprehensive and coherent summary. The present disclosure is directed towards such a system and method.

### SUMMARY

In some embodiments, a method for multistage information processing includes receiving a user query from a user device; transforming, using a machine learning algorithm, the user query into a set of vectors representing a semantic meaning of the query in a high-dimensional space; comparing each of the set of vectors against a vector database of pre-vectorized documents, wherein each of a set of documents are pre-vectorized in the high-dimensional space; ranking a closeness of pre-vectorized documents to the set of vectors to determine a subset of the set of documents; generating, using a large language model, metadata based on the subset of the set of documents; synthesizing the metadata to generate a comprehensive summary; and transmitting the comprehensive summary to the user device in response to the user query.

In some embodiments, comparing the set of vectors against a vector database of pre-vectorized documents includes identifying the subset of the set of documents that fall within a predefined confidence cone around each of the set of vectors.

In some embodiments, synthesizing the metadata to generate the comprehensive summary further includes including references to at least one of the subset of the set of documents.

In some embodiments, the method further includes verifying the comprehensive summary for accuracy by: extracting claims made in the comprehensive summary; comparing, by a plurality with content; and removing claims that are unverified by the subset of the set of documents.

In some embodiments, the comparison of each of the set of vectors against a vector database of pre-vectorized documents is performed in parallel.

In some embodiments, the method further includes segmenting each of the set documents to under a predetermined size based on a context window the large language model.

In some embodiments, transforming the user query into the set of vectors includes: generating multiple vectors based on a complexity of the user query; and determining a number of vectors to generate dynamically based on at least one of: the complexity of the query, a size of set of documents, or available computational resources.

In some embodiments, a system for multistage information processing includes: a processor; and a memory storing instructions that, when executed by the processor, cause the processor to: receive a user query from a user device; transform, using a machine learning algorithm, the user query into a set of vectors representing a semantic meaning of the query in a high-dimensional space; compare each of the set of vectors against a vector database of pre-vectorized documents, wherein each of a set of documents are pre-vectorized in the high-dimensional space; rank a closeness of pre-vectorized documents to the set of vectors to determine a subset of the set of documents; generate, using a large language model, metadata based on the subset of the set of documents; synthesize the metadata to generate a comprehensive summary; and transmit the comprehensive summary to the user device in response to the user query.

In some embodiments, comparing the set of vectors against a vector database of pre-vectorized documents includes identifying the subset of the set of documents that fall within a predefined confidence cone around each of the set of vectors.

In some embodiments, synthesizing the metadata to generate the comprehensive summary further includes including references to at least one of the subset of the set of documents.

In some embodiments, the memory stores further instructions that, when executed by the processor, cause the processor to: verify the comprehensive summary for accuracy by: extracting claims made in the comprehensive summary; comparing, by a plurality with content; and removing claims that are unverified by the subset of the set of documents.

In some embodiments, the comparison of each of the set of vectors against a vector database of pre-vectorized documents is performed in parallel.

In some embodiments, the memory stores further instructions that, when executed by the processor, cause the processor to segment each of the set documents to under a predetermined size based on a context window of the large language model.

In some embodiments, transforming the user query into the set of vectors includes: generating multiple vectors based on a complexity of the user query; and determining a number of vectors to generate dynamically based on at least one of: the complexity of the query, a size of set of documents, or available computational resources.

In some embodiments, a non-transitory computer-readable medium storing instructions that, when executed by a processor, causes the processor to perform a method for multistage information processing, the processing including: receiving a user query from a user device; transforming, using a machine learning algorithm, the user query into a set of vectors representing a semantic meaning of the query in a high-dimensional space; comparing each of the set of vectors against a vector database of pre-vectorized documents, wherein each of a set of documents are pre-vectorized in the high-dimensional space; ranking a closeness of pre-vectorized documents to the set of vectors to determine a subset of the set of documents; generating, using a large language model, metadata based on the subset of the set of documents; synthesizing the metadata to generate a comprehensive summary; and transmitting the comprehensive summary to the user device in response to the user query.

In some embodiments, comparing the set of vectors against a vector database of pre-vectorized documents includes identifying the subset of the set of documents that fall within a predefined confidence cone around each of the set of vectors.

In some embodiments, synthesizing the metadata to generate the comprehensive summary further includes including references to at least one of the subset of the set of documents.

In some embodiments, the processing further includes: verifying the comprehensive summary for accuracy by: extracting claims made in the comprehensive summary; comparing, by a plurality with content; and removing claims that are unverified by the subset of the set of documents.

In some embodiments, the comparison of each of the set of vectors against a vector database of pre-vectorized documents is performed in parallel.

In some embodiments, the processing further includes segmenting each of the set documents to under a predetermined size based on a context window of the large language model.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. Various aspects of at least one example are discussed below with reference to the accompanying drawings, which are not intended to be drawn to scale. In the drawings:

FIG. 1 depicts an illustrative flowchart for a multistage information retrieval and synthesis process in accordance with an embodiment.

FIG. 2 illustrates a block diagram of an example data processing system in which embodiments are implemented.

FIG. 3 illustrates a block diagram for a multistage information retrieval and synthesis system in accordance with an embodiment.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

The present disclosure provides a multistage process for retrieving and synthesizing information from a large corpus of documents. This process addresses the limitations of traditional search engines and other information retrieval methods, which often rely on keyword-based searches and may not fully understand the conceptual relevance of documents to a given query. Furthermore, this process aims to mitigate the issue of “hallucination” often encountered in large language models (LLMs), where the model generates information that sounds plausible but is not substantiated by the source documents.

The multistage process disclosed herein leverages advanced computational techniques to improve the accuracy and relevance of the information retrieved. The process comprises five distinct stages: query vectorization, parallel document retrieval, independent note-taking, synthesis of notes, and optional verification. Each stage is designed to enhance the overall effectiveness of the information retrieval and synthesis process.

In the query vectorization stage, the user's query is transformed into a set of vectors that represent the conceptual space of the query, rather than specific keywords. This transformation allows for a more nuanced understanding of the query and facilitates more accurate document retrieval.

The parallel document retrieval stage involves comparing the query vectors against a pre-vectorized document database to identify relevant documents. This stage also includes the selection of a specified number of documents based on their relevance to the query vectors.

In the independent note-taking stage, each selected document is processed independently using an LLM to extract relevant information and generate notes or summaries. If a document is larger than the LLM's context window size, it is further subdivided and processed in parts.

The synthesis of notes stage involves combining the independently generated notes to create a comprehensive summary that addresses the query effectively. This stage also ensures that the final summary includes footnotes and references to the source documents.

Finally, the optional verification stage involves checking the accuracy and relevance of the synthesized summary. Each claim made in the summary is extracted and verified against the referenced documents. If a claim is found to be non-existent in the source document, the claim is removed, and the summarization and verification process is re-run.

This multistage process for information retrieval and synthesis may find applicability in various industries where accurate and relevant information retrieval is of paramount concern, such as legal research, academic research, market analysis, and any field requiring detailed and reliable information synthesis from large datasets.

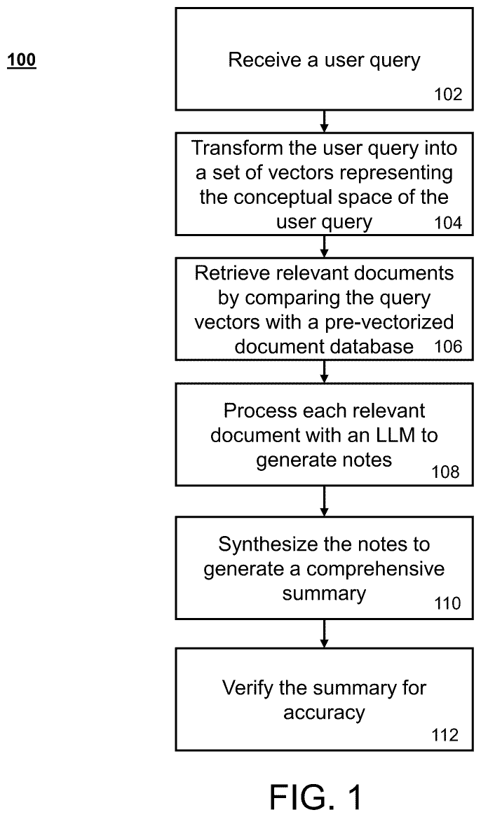

Referring to FIG. 1, the multistage information retrieval and synthesis process 100 begins with step 102, where a user query is received. In some aspects, the user query may be a simple question, a complex research topic, or any other form of information request. The user query is then transformed into a set of vectors in step 104, which is also known as the query vectorization stage. This transformation is facilitated by a query vectorization module, which may be a software component, a hardware component, or a combination of both.

In some cases, the query vectorization module is configured to transform the user query into a set of vectors representing the conceptual space of the query. This transformation may involve breaking down the user query into n-dimensional vectors. The n-dimensional vectors may capture the semantic meaning of the query rather than the specific keywords.

In some aspects, the query vectorization module may generate multiple vectors based on the complexity of the user query. For instance, a simple query may be represented by two or three vectors, while a complex query may be represented by ten or more vectors. The number of vectors generated may be determined dynamically based on the complexity of the query, the size of the document corpus, the computational resources available, or other factors.

In some embodiments, the query vectorization module may be a machine learning model. The machine learning model may be trained by learning to predict words in a document given the document's vector representation. In some aspects, the algorithm may use Distributed Memory (DM) and Distributed Bag of Words (DBOW). DM may allow the model to consider the order and context of words, potentially capturing more nuanced semantic relationships. DBOW, on the other hand, may be more efficient in processing large amounts of text and may be less sensitive to word order, which can be beneficial for certain types of queries. The combination of these approaches may result in a more robust and versatile vectorization process, capable of handling a wide range of query types and complexities.

In addition to DM and DBOW, other machine learning models may be employed for generating vector representations. For instance, transformer-based models such as BERT (Bidirectional Encoder Representations from Transformers) or its variants may be used. These models may offer improved performance in capturing contextual information and handling complex linguistic structures. In some cases, models based on neural networks, such as recurrent neural networks (RNNs) or convolutional neural networks (CNNs), may be utilized for vector generation. Each of these models may have its own strengths and may be selected based on factors such as the specific requirements of the query vectorization task, the available computational resources, and the characteristics of the document corpus.

In the context of query vectorization, the machine learning model may be used to generate a vector representation of the user query. This vector may capture the semantic meaning of the query in a high-dimensional space, allowing for more nuanced comparisons with document vectors in the subsequent parallel document retrieval stage.

The machine learning model may offer several advantages. It may capture semantic relationships between words and phrases, allowing for a more comprehensive understanding of the query's intent. It may also handle out-of-vocabulary words and be less sensitive to word order, potentially improving robustness in handling various query formulations. The machine learning model can incorporate any of a variety of techniques to perform the processes as described herein, such as supervised learning, unsupervised learning, reinforcement learning, etc.

In some aspects, the query vectorization module may also generate a keyword search string or a vector search string based on the generated vectors. This search string may be used in the subsequent parallel document retrieval stage to identify relevant documents in the document database. The generation of the search string may involve various techniques, such as vector-to-string conversion, keyword extraction, or other suitable methods.

Continuing with the description of FIG. 1, the multistage information retrieval and synthesis process 100 proceeds to step 106, which is the parallel document retrieval stage. In some aspects, this stage may involve a parallel document retrieval module, which may be a software component, a hardware component, or a combination of both. The parallel document retrieval module may be configured to retrieve documents in parallel by comparing the query vectors against a pre-vectorized document database.

In some embodiments, the parallel document retrieval module may be configured to select a specified number of documents based on their relevance to the query vectors or the generated search terms. The relevance of a document may be determined by comparing the query vectors with the document vectors using a mathematical method, such as cosine similarity. The documents with the closest similarity to the query vectors may be considered the most relevant and selected for further processing.

In some aspects, the parallel document retrieval module may identify a subset of documents that fall within a predefined confidence cone around the query vector. The confidence cone may be a region in the vector space that encompasses documents with a high degree of similarity to the query vectors. Documents that fall within this confidence cone may be considered relevant to the query and selected for further processing.

In some embodiments, the parallel document retrieval module may also store metadata about the retrieved documents, such as the URL or other reference information. This metadata may be used in later stages of the process 100 for note-taking, synthesis, and verification.

In some aspects, the parallel document retrieval module may also handle different types of content, such as HTML documents, PDF files, text files, and others. The module may be configured to extract relevant sections from these documents, such as paragraphs from HTML documents or sections from PDF files, based on their relevance to the query vectors or the generated search terms.

In some cases, the parallel document retrieval module may also handle different languages, using language models trained on multilingual corpora to vectorize and retrieve documents in different languages. This feature may enable the process 100 to handle queries and documents in a wide range of languages, broadening its applicability and usefulness.

Continuing with the description of FIG. 1, the multistage information retrieval and synthesis process 100 advances to step 108, which is the independent note-taking stage. In some aspects, this stage may involve an independent note-taking module, which may be a software component, a hardware component, or a combination of both. The independent note-taking module may be configured to process each retrieved document independently using a large language model (LLM) to extract relevant information and generate additional metadata, including notes or summaries.

In some aspects, the large language model (LLM) may process data through a series of complex computational steps. The LLM may tokenize the input text, breaking it down into smaller units such as words or subwords. These tokens may then be converted into numerical representations or embeddings, which capture semantic information. The model may process these embeddings through multiple layers of neural networks, using self-attention mechanisms to weigh the importance of different parts of the input. Each layer may transform the representations, potentially capturing increasingly abstract features of the text. The final layer may output a probability distribution over possible next tokens, which can be used for various tasks such as text generation, classification, or information extraction. In some cases, the LLM may employ techniques like beam search or nucleus sampling to generate coherent and diverse outputs.

In some embodiments, the independent note-taking module may process each selected document in parts if the document is larger than the LLM's context window size. This subdivision of documents may be performed dynamically based on the size of the document and the context window size of the LLM. The context window size may refer to the maximum number of words or characters that the LLM can process at once. If a document exceeds this size, it may be divided into smaller parts that fit within the context window size. Each part may then be processed independently, and the results may be combined to generate a comprehensive set of notes for the document.

In some aspects, the independent note-taking module may use an LLM to generate relevant notes from each document. The LLM may be a machine learning model trained on a large corpus of text, capable of understanding and generating human-like text. The LLM may extract relevant information from each document based on the initial query, and generate notes or summaries that capture the relevant points to the query. The notes or summaries may be stored for later use in the synthesis stage of the process 100.

In some cases, the independent note-taking module may use different LLMs for different documents or parts of documents. For instance, one LLM may be used for processing scientific articles, while another LLM may be used for processing legal documents. The choice of LLM may be determined based on the type of document, the subject matter of the document, the language of the document, or other factors.

In some aspects, the different LLMs used by the independent note-taking module may be distinctly fine-tuned versions of a base LLM. Fine-tuning may involve further training of a pre-trained LLM on a specific dataset, allowing the model to adapt its knowledge and capabilities to a specialized domain.

The process of fine-tuning LLMs may involve several steps. Initially, a pre-trained LLM, which has been trained on a large corpus of general text data, may be selected as the starting point. This pre-trained model may then be further trained on a smaller, more specialized dataset relevant to the target domain. During fine-tuning, the model's parameters may be adjusted to optimize performance on the specific task or domain while retaining the general knowledge acquired during pre-training.

In some cases, fine-tuning may focus on adapting the LLM to understand and generate text in a particular style, format, or domain-specific vocabulary. For example, an LLM fine-tuned for processing scientific articles may be trained on a corpus of scientific papers, allowing it to better understand technical terminology and scientific writing conventions. Similarly, an LLM fine-tuned for legal documents may be trained on legal texts, enabling it to interpret and generate text using appropriate legal language and concepts.

The fine-tuning process may also involve adjusting the model's hyperparameters, such as learning rate, batch size, or number of training epochs, to optimize performance on the target task. In some instances, only certain layers of the LLM may be fine-tuned while keeping others frozen, a technique known as partial fine-tuning, which may help preserve general knowledge while adapting to specific tasks.

By using distinctly fine-tuned LLMs, the independent note-taking module may potentially achieve better performance in extracting relevant information and generating notes from different types of documents. The fine-tuned models may be more adept at understanding domain-specific nuances, terminology, and context, leading to more accurate and relevant note generation across various document types and subject matters.

In some aspects, portions of the domain-specific training set used for fine-tuning LLMs may be vectorized using similar techniques employed in the query vectorization stage. This vectorization process may involve transforming the textual content of the training set into high-dimensional vector representations that capture semantic meanings and relationships. The vectorized portions of the training set may then be associated with their respective fine-tuned LLMs. When processing a new query or document, the system may compare the vector representation of the input against the vectorized portions of the training sets. This comparison may utilize techniques such as cosine similarity or other distance metrics in the vector space. The fine-tuned LLM associated with the training set portion that exhibits the highest similarity to the input may be selected as the most relevant model for processing that particular query or document. This approach may enable dynamic selection of the most appropriate fine-tuned LLM based on the specific characteristics and domain of the input, potentially enhancing the accuracy and relevance of the information extraction and note generation process.

In some embodiments, the independent note-taking module may also store metadata about the notes or summaries generated, such as the source document, the section of the document from which the note was extracted, the LLM used for note-taking, or other information. This metadata may be used in later stages of the process 100 for synthesis and verification.

In some aspects, the independent note-taking module may also handle different types of content, such as text, images, tables, or other forms of data. The module may be configured to extract relevant information from these different types of content and generate notes or summaries accordingly. For instance, for an image, the module may use an image recognition model to identify objects or features in the image and generate a description or summary of the image. For a table, the module may extract relevant data from the table and generate a summary or interpretation of the data.

Referring again to FIG. 1, the multistage information retrieval and synthesis process 100 proceeds to step 110, which is the synthesis of notes stage. In some aspects, this stage may involve a synthesis module, which may be a software component, a hardware component, or a combination of both. The synthesis module may be configured to synthesize the independently generated notes to create a comprehensive summary that addresses the query effectively.

In some embodiments, the synthesis module may be a different instantiation of a large language model (LLM) or a different LLM altogether. The synthesis module may be configured to combine the relevant information from all notes, ensuring that the final summary addresses the query effectively. This synthesis may involve various techniques, such as text summarization, information fusion, or other suitable methods.

In some aspects, the synthesis module may be instructed to include footnotes and references as part of its synthesis. This feature may ensure that the synthesized summary is traceable to the source documents and that it does not include any unsubstantiated information. The footnotes and references may be automatically inserted by the synthesis module based on the metadata stored during the independent note-taking stage.

In some cases, the synthesis module may also be configured to handle different types of content, such as text, images, tables, or other forms of data. The module may be configured to synthesize information from these different types of content and generate a comprehensive summary accordingly. For instance, for an image, the module may use an image recognition model to identify objects or features in the image and include a description or summary of the image in the final summary. For a table, the module may extract relevant data from the table and include a summary or interpretation of the data in the final summary.

In some embodiments, the synthesis module may also handle different languages, using language models trained on multilingual corpora to synthesize notes in different languages. This feature may enable the process 100 to handle notes and summaries in a wide range of languages, broadening its applicability and usefulness.

Referring again to FIG. 1, the multistage information retrieval and synthesis process 100 may further include an optional verification stage, represented as step 112. In some aspects, this stage may involve an optional verification module, which may be a software component, a hardware component, or a combination of both. The optional verification module may be configured to verify the synthesized summary for accuracy and relevance.

In some embodiments, the optional verification module may be configured to extract each claim made from the synthesized summary along with its reference. The module may then verify that the claim made is actually present in the referenced documents. This verification process may involve comparing the claim with the content of the referenced document, using a large language model (LLM) or other suitable method to understand the content of the document and determine whether it supports the claim.

In some aspects, the optional verification module may use a majority voting system if more than one LLM instantiation is used per claim. For instance, if three LLM instantiations are used to verify a claim, and two of them agree that the claim is supported by the referenced document, then the claim may be considered verified. This majority voting system may increase the robustness of the verification process and reduce the likelihood of false positives or negatives.

In some cases, if a claim is found to be non-existent in the source document, the claim may be removed from the synthesized summary. The removal of the claim may involve regenerating at least one of the note-taking, synthesis, and verification stages (steps 108, 110, and 112) of process 100. This regeneration may ensure that the final synthesized summary is accurate and substantiated by the source documents.

The described invention can be applied in various industries where accurate and relevant information retrieval is critical, such as legal research, academic research, market analysis, and any field requiring detailed and reliable information synthesis from large datasets.

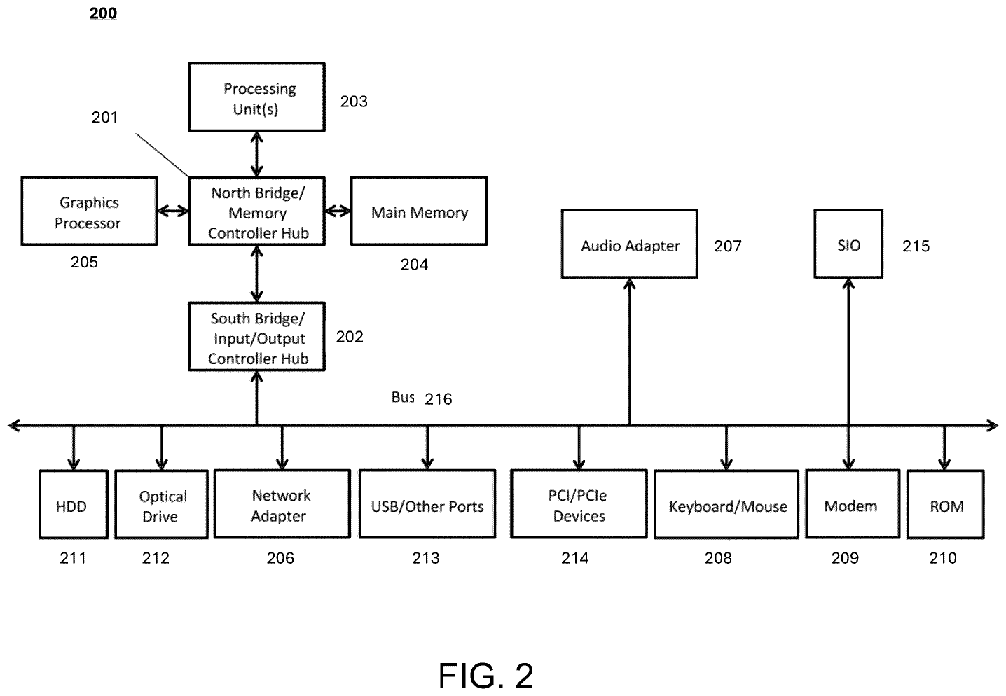

FIG. 2 illustrates a block diagram of an example data processing system 200 in which embodiments are implemented. The data processing system 200 is an example of a computer, such as a server or client, in which computer usable code or instructions implementing the process for illustrative embodiments of the present invention are located. In some embodiments, the data processing system 200 may be a server computing device. The data processing system 200 may be configured to, for example, perform processing associated with the machine learning models or LLMs described herein.

In the depicted example, the data processing system 200 may employ a hub architecture including a north bridge and memory controller hub (NB/MCH) 201 and south bridge and input/output (I/O) controller hub (SB/ICH) 202. A processing unit 203, a main memory 204, and a graphics processor 205 may be connected to the NB/MCH 201. The graphics processor 205 may be connected to the NB/MCH 201 through, for example, an accelerated graphics port (AGP).

In the depicted example, a network adapter 206 connects to the SB/ICH 202. An audio adapter 207, a keyboard and mouse adapter 208, a modem 209, a read only memory (ROM) 210, a hard disk drive (HDD) 211, an optical drive (e.g., CD or DVD) 212, a universal serial bus (USB) ports and other communication ports 213, and PCI/PCIe devices 214 may connect to the SB/ICH 202 through a bus system 216. The PCI/PCIe devices 214 may include Ethernet adapters, add-in cards, and/or PC cards for notebook computers. The ROM 210 may be, for example, a flash basic input/output system (BIOS). The HDD 211 and the optical drive 212 may use an integrated drive electronics (IDE) or serial advanced technology attachment (SATA) interface. A super I/O (SIO) device 215 may be connected to the SB/ICH 202.

An operating system may run on the processing unit 203. The operating system may coordinate and provide control of various components within the data processing system 200. As a client, the operating system may be a commercially available operating system. An object-oriented programming system, such as the Java™ programming system, may run in conjunction with the operating system and provide calls to the operating system from the object-oriented programs or applications executing on the data processing system 200. As a server, the data processing system 200 may be an IBM® eServer™ System® running the Advanced Interactive Executive operating system or the Linux operating system. The data processing system 200 may be a symmetric multiprocessor (SMP) system that can include a plurality of processors in the processing unit 203. Alternatively, a single processor system may be employed.

Instructions for the operating system, the object-oriented programming system, and applications or programs are located on storage devices, such as the HDD 211, and are loaded into the main memory 204 for execution by the processing unit 203. The processes for embodiments described herein may be performed by processing unit 203 using computer usable program code, which can be located in a memory such as, for example, main memory 204, ROM 210, or in one or more peripheral devices.

A bus system 216 may comprise one or more busses. The bus system 216 may be implemented using any type of communication fabric or architecture that provides for a transfer of data between different components or devices attached to the fabric or architecture. A communication unit such as the modem 209 or the network adapter 206 may include one or more devices that can be used to transmit and receive data.

Those of ordinary skill in the art will appreciate that the hardware depicted in FIG. 2 may vary depending on the implementation. Other internal hardware or peripheral devices, such as flash memory, equivalent non-volatile memory, or optical disk drives may be used in addition to or in place of the hardware depicted. Moreover, the data processing system 200 can take the form of any of a number of different data processing systems, including but not limited to, client computing devices, server computing devices, tablet computers, laptop computers, telephone or other communication devices, personal digital assistants, and the like. Essentially, data processing system 200 can be any known or later developed data processing system without architectural limitation.

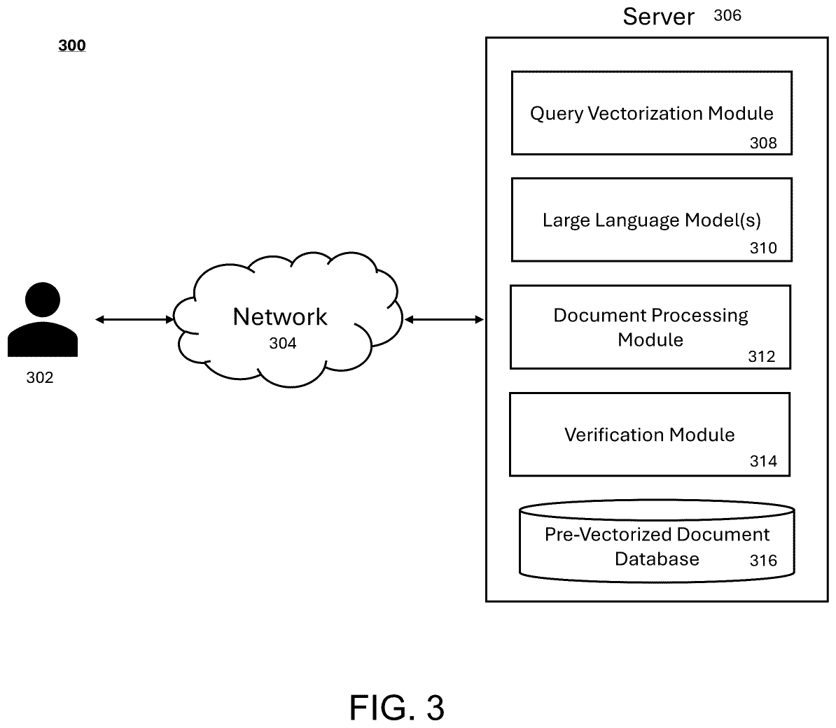

FIG. 3 illustrates a block diagram of an information processing system 300 for multistage information retrieval and synthesis. The system 300 may include a user device 302 connected to a server system 306 through a network 304. The user device 302 may be any computing device capable of sending queries and receiving responses, such as a personal computer, smartphone, tablet, or other suitable device.

Network 304 may be implemented using various communication technologies, such as wired or wireless networks, including but not limited to Ethernet, Wi-Fi, cellular networks (e.g., 4G, 5G), or fiber optic networks. In some aspects, the network 304 may comprise a combination of different network types, such as a local area network (LAN) connected to a wide area network (WAN) or the Internet. Network 304 may also incorporate security measures, such as encryption protocols or virtual private network (VPN) technologies, to ensure secure transmission of data between the user device 302 and the server system 306.

The server system 306 may comprise several modules that work together to process user queries and generate comprehensive summaries in response. A query vectorization module 308 may be responsible for transforming user queries into vector representations. This module may utilize machine learning algorithms to capture the semantic meaning of queries in a high-dimensional space.

The server system 306 may also include one or more language model modules 310. These modules may implement large language models (LLMs) that can process and generate human-like text. In some aspects, the language model modules 310 may be used for various tasks throughout the information retrieval and synthesis process, such as document processing, note generation, summary synthesis, and verification.

A document processing module 312 may be present in server system 306. This module may handle tasks related to document retrieval, segmentation, and comparison. In some embodiments, the document processing module 312 may work in conjunction with a pre-vectorized document database 316, which stores vector representations of documents for efficient comparison and retrieval.

The server system 306 may also include a verification module 314. This module may be responsible for verifying the accuracy and relevance of the synthesized summaries. In some cases, the verification module 314 may employ multiple LLM instantiations to cross-check claims made in the summaries against the source documents.

The components of the information processing system 300 may work together to provide a comprehensive solution for multistage information retrieval and synthesis. The system may process user queries, retrieve relevant documents, generate notes, synthesize summaries, and verify the accuracy of the results, all while leveraging advanced natural language processing and machine learning techniques.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed:

1. A method for multistage information processing, the method comprising:
receiving a user query from a user device;
transforming, using a machine learning algorithm, the user query into a set of vectors representing a semantic meaning of the query in a high-dimensional space;
comparing each of the set of vectors against a vector database of pre-vectorized documents, wherein each of a set of documents are pre-vectorized in the high-dimensional space;
ranking a similarity of pre-vectorized documents to the set of vectors to determine a subset of the set of documents;
generating, using a large language model, metadata based on the subset of the set of documents;
synthesizing the metadata to generate a comprehensive summary; and
transmitting the comprehensive summary to the user device in response to the user query.

2. The method of claim 1, wherein comparing the set of vectors against a vector database of pre-vectorized documents comprises identifying the subset of the set of documents that fall within a predefined confidence cone around each of the set of vectors.

3. The method of claim 1, wherein synthesizing the metadata to generate the comprehensive summary further comprises including references to at least one of the subset of the set of documents.

4. The method of claim 1, further comprising:
verifying the comprehensive summary for accuracy by:
extracting claims made in the comprehensive summary;
comparing, by a plurality of large language models, each extracted claim with content of the subset of the set of documents;
determining a majority of the plurality of large language models verify each extracted claim; and
removing claims that are unverified by the subset of the set of documents.

5. The method of claim 1, wherein the comparing of each of the set of vectors against a vector database of pre-vectorized documents is performed in parallel.

6. The method of claim 1, further comprising segmenting each of the set documents to under a predetermined size based on a context window the large language model.

7. The method of claim 1, wherein transforming the user query into the set of vectors comprises:
generating multiple vectors based on a complexity of the user query; and
determining a number of vectors to generate dynamically based on at least one of: the complexity of the query, a size of set of documents, or available computational resources.

8. A system for multistage information processing, comprising:
a processor; and
a memory storing instructions that, when executed by the processor, cause the processor to:
receive a user query from a user device;
transform, using a machine learning algorithm, the user query into a set of vectors representing a semantic meaning of the query in a high-dimensional space;
compare each of the set of vectors against a vector database of pre-vectorized documents, wherein each of a set of documents are pre-vectorized in the high-dimensional space;
rank a closeness of pre-vectorized documents to the set of vectors to determine a subset of the set of documents;
generate, using a large language model, metadata based on the subset of the set of documents;
synthesize the metadata to generate a comprehensive summary; and
transmit the comprehensive summary to the user device in response to the user query.

9. The system of claim 8, wherein comparing the set of vectors against a vector database of pre-vectorized documents comprises identifying the subset of the set of documents that fall within a predefined confidence cone around each of the set of vectors.

10. The system of claim 8, wherein synthesizing the metadata to generate the comprehensive summary further comprises including references to at least one of the subset of the set of documents.

11. The system of claim 8, wherein the memory stores further instructions that, when executed by the processor, cause the processor to:
verify the comprehensive summary for accuracy by:
extracting claims made in the comprehensive summary;
comparing, by a plurality of large language models, each extracted claim with content of the subset of the set of documents;
determining a majority of the plurality of large language models verify each extracted claim; and
removing claims that are unverified by the subset of the set of documents.

12. The system of claim 8, wherein the comparison of each of the set of vectors against a vector database of pre-vectorized documents is performed in parallel.

13. The system of claim 8, wherein the memory stores further instructions that, when executed by the processor, cause the processor to segment each of the set documents to under a predetermined size based on a context window of the large language model.

14. The system of claim 8, wherein transforming the user query into the set of vectors comprises:
generating multiple vectors based on a complexity of the user query; and
determining a number of vectors to generate dynamically based on at least one of: the complexity of the query, a size of set of documents, or available computational resources.

15. A non-transitory computer-readable medium storing instructions that, when executed by a processor, cause the processor to perform a method for multistage information processing, the method comprising:
receiving a user query from a user device;
transforming, using a machine learning algorithm, the user query into a set of vectors representing a semantic meaning of the query in a high-dimensional space;
comparing each of the set of vectors against a vector database of pre-vectorized documents, wherein each of a set of documents are pre-vectorized in the high-dimensional space;
ranking a closeness of pre-vectorized documents to the set of vectors to determine a subset of the set of documents;
generating, using a large language model, metadata based on the subset of the set of documents;
synthesizing the metadata to generate a comprehensive summary; and
transmitting the comprehensive summary to the user device in response to the user query.

16. The non-transitory computer-readable medium of claim 15, wherein comparing the set of vectors against a vector database of pre-vectorized documents comprises identifying the subset of the set of documents that fall within a predefined confidence cone around each of the set of vectors.

17. The non-transitory computer-readable medium of claim 15, wherein synthesizing the metadata to generate the comprehensive summary further comprises including references to at least one of the subset of the set of documents.

18. The non-transitory computer-readable medium of claim 15, wherein the method further comprises:
verifying the comprehensive summary for accuracy by:
extracting claims made in the comprehensive summary;
comparing, by a plurality of large language models, each extracted claim with content of the subset of the set of documents;
determining a majority of the plurality of large language models verify each extracted claim; and
removing claims that are unverified by the subset of the set of documents.

19. The non-transitory computer-readable medium of claim 15, wherein the comparison of each of the set of vectors against a vector database of pre-vectorized documents is performed in parallel.

20. The non-transitory computer-readable medium of claim 15, wherein the method further comprises segmenting each of the set documents to under a predetermined size based on a context window of the large language model.
